(19) United States
(12) Patent Application Publication
(10) Pub. No.: US 2026/0113327 A1
(43) Pub. Date: Apr. 23, 2026

(54) NETWORK SECURITY SYSTEM

(71) Applicants: CHAO-HUNG LIN, New Taipei City (TW); Farxun Wisdom INC., New Taipei City (TW)

(72) Inventor: CHAO-HUNG LIN, New Taipei City (TW)

(21) Appl. No.: 19/359,575

(22) Filed: Oct. 15, 2025

(30) Foreign Application Priority Data
Oct. 18, 2024 (TW) 113139712

(51) Int. Cl. H04L 9/40; H04L 41/16

(52) U.S. Cl. CPC H04L 63/102; H04L 41/16; H04L 63/0236; H04L 63/1433; H04L 63/1483

(57) ABSTRACT

A computer-implemented network security system processes multi-source data (images, text, and URLs) to detect harmful content and prevent navigation to malicious destinations. An AI analysis module performs image recognition, optical character recognition, and semantic analysis to generate content-level features. A link analysis module parses HTTP headers to identify and record HTTP 3xx redirect responses, reconstructs a complete redirect chain and navigation path, and derives path-level features—including URL entropy, domain age, TLS/SSL certificate validity, and suspicious query parameters. The system fuses the path-level and content-level features to classify the navigation path or compute a risk score, and proactively blocks access when a blocking condition is met. A user interface presents real-time security indicators and warnings. In some embodiments, the system manages dynamic whitelists/blacklists, consults threat-intelligence sources, reports suspicious chains to authorities, and supports family-monitoring and audio-stream analysis.

### FIELD OF THE INVENTION

The present disclosure relates to network security and, more particularly, to an artificial intelligence (AI)-driven network security system configured to detect, analyze, and mitigate cyber threats. The system employs advanced machine-learning techniques to provide real-time protection against a variety of malicious activities, including, without limitation, phishing attacks, fraud, dissemination of harmful content, and attempts at unauthorized access.

### BACKGROUND OF THE INVENTION

With the explosive growth of the Internet and digital communication platforms both the volume and sophistication of cyber threats have increased markedly. Individuals and enterprises are continually exposed to a wide range of online risks. For example phishing attacks are deceptive schemes that impersonate trusted entities to obtain sensitive information. The spread of harmful content—including sexually explicit material, gambling-related material, drug-related information, and other unlawful content—also presents significant risk. Fraud schemes are designed to trick users into disclosing personal information or financial details, or into executing unauthorized transactions. Malware and ransomware are further engineered to damage, disrupt, or obtain unauthorized access to computer systems.

### Conventional network-security solutions largely rely on signature-based detection. Such systems use databases of known threat signatures to identify and block malicious activity. Although effective for previously identified threats, signature-based solutions have notable limitations, particularly an inability to detect zero-day attacks—new, previously unknown threats that evade systems lacking corresponding signatures. In addition these solutions tend to operate reactively, identifying threats only after they have been cataloged and their signatures distributed, which can introduce mitigation delays. The frequent updates needed to maintain signature databases further increase maintenance overhead and resource consumption.

Accordingly, there remains a need for improved network-security solutions that overcome these limitations by providing comprehensive multi-modal analysis, real-time processing and alerting, adaptive learning, a scalable architecture, and a user-friendly interface. Such solutions should be capable of concurrently analyzing multiple data types—including text, images, and URLs—to deliver broader threat detection. High-performance processing is critical to minimize response time and reduce potential harm. Dynamic machine-learning methods that learn continuously from new data are desirable to adapt to and predict emerging threats without extensive manual updates. A scalable system design that accommodates growth in data volume and user base is likewise important for personal and enterprise deployments. Finally, an intuitive interface that supports users with varying technical proficiency—including specialized features for family monitoring and the protection of vulnerable users such as minors and seniors—is highly desirable.

### SUMMARY OF THE INVENTION

In one aspect, a computer-implemented network security system processes multi-source data to detect, analyze, and mitigate cyber threats in real time. The system includes an AI analysis module that generates content-level features from received data—such as images, textual content, and URLs—using image recognition, optical character recognition (OCR), and semantic analysis. A link-analysis module parses HTTP headers to identify and record HTTP 3xx redirect responses, reconstructs a complete redirect chain and navigation path from an initial website to a final destination, and derives path-level features (e.g., URL entropy, domain age, TLS/SSL certificate validity, and suspicious query parameters). The link-analysis module fuses the path-level features with the content-level features to classify the navigation path or compute a path-level risk score and, when a blocking condition is met, proactively blocks navigation prior to landing on the destination. A user-interface module presents real-time security indicators and displays the blocking result.

In some embodiments, the link-analysis module manages dynamic lists of known-safe and known-dangerous URLs and performs AI-based evaluation of URLs not present on those lists. In certain implementations, a family-monitoring module enables a guardian to create and manage multiple user profiles with profile-specific filtering and access permissions. An audio interface can capture audio streams, convert speech to text, and apply the AI analysis module’s semantic analysis to the transcript to identify indicators of fraud or other malicious intent. The user interface may include a status dashboard that presents real-time security indicators using a color-coded scheme, and the system can generate real-time alerts based on assigned risk scores.

In various embodiments, the AI analysis module may employ a Transformer-based architecture and retrieval-augmented generation (RAG) to improve adaptation to emerging threats, and may further utilize dynamic machine-learning techniques to learn from new data on a continual basis. The foregoing features can be implemented individually or in combination, and the scope of the disclosure is defined by the claims.

### BRIEF DESCRIPTION OF THE DRAWINGS

The accompanying drawings are provided to illustrate exemplary embodiments of the present invention and are not intended to limit the scope thereof. Identical reference numerals denote identical elements throughout the drawings.

FIG. 1 is a block diagram of an example network security system according to certain embodiments.

FIG. 2 is a flowchart illustrating an example operation of an AI analysis module.

FIG. 3A is a diagram of an example layout of a user-interface module.

FIG. 3B is another diagram of an example layout of the user-interface module.

FIG. 4 is a flowchart illustrating an example operation of the network security system.

### DESCRIPTION OF THE PREFERRED EMBODIMENTS

In some embodiments, the disclosed network security system is an AI-driven cybersecurity platform that provides comprehensive, real-time protection against multiple categories of online threats. The system employs advanced machine-learning algorithms—including image recognition, optical character recognition (OCR), and natural-language-processing-based semantic analysis—to detect and mitigate harmful content appearing across multiple data modalities, such as images, textual content, and URLs. The system is designed to operate cohesively in personal, family, and enterprise environments so that protective measures can update and adapt as threats evolve.

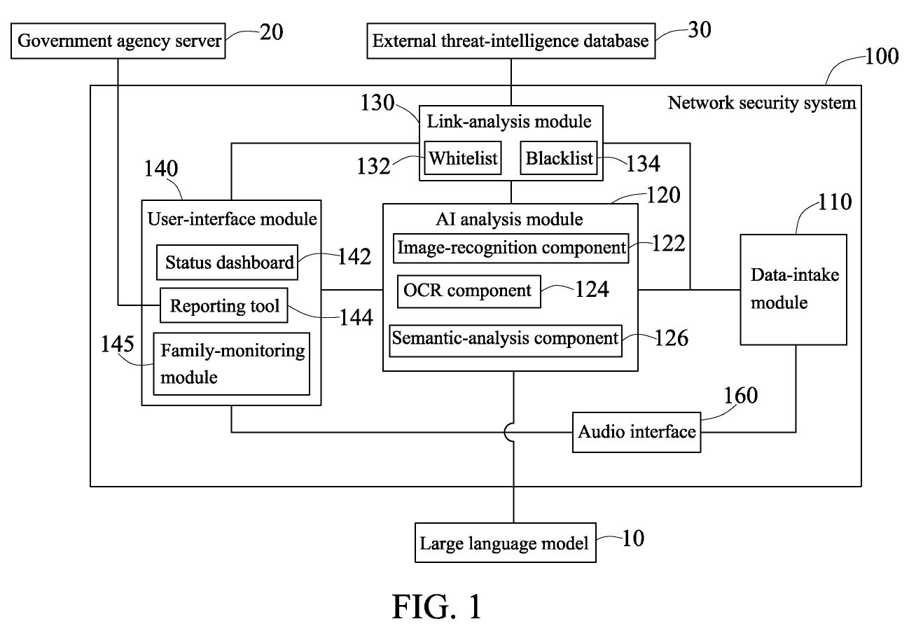

Referring to FIG. 1, which illustrates a block diagram of one embodiment of the network security system 100, the system includes multiple interrelated modules and components that cooperate to provide security functionality. In the illustrated arrangement, principal modules and components of the system 100 include a data-intake module 110, an AI analysis module 120, a link-analysis module 130, a user-interface module 140, a family-monitoring module 145, and an audio interface 160.

In the embodiment shown, the data-intake module 110 serves as the ingress for data entering the system 100. The data-intake module 110 is configured to receive and aggregate diverse types of data from various sources. The sources may include user devices, webpages, and online communications, and the data types may include images, textual content, and Uniform Resource Locators (URLs). The data-intake module 110 performs preprocessing and normalization of incoming data to prepare it for subsequent analysis by the AI analysis module 120.

In certain implementations, data collection is accomplished by aggregating inputs from multiple sources, including real-time web-browsing activity, messaging platforms, and user-uploaded content. The preprocessing performed by the data-intake module 110 can include standardizing data formats, performing an initial filtering to remove irrelevant information, and otherwise preparing the data for analysis. The data-intake module 110 may further route the processed data to appropriate modules or components within the network security system 100 for additional analysis.

In some embodiments, the AI analysis module 120 employs multiple machine-learning models and algorithms to analyze and interpret received data. The AI analysis module 120 is responsible for identifying and classifying harmful content, adapting to emerging threats, and generating actionable mitigation insights. In the illustrated embodiment, an image-recognition component 122 may utilize a convolutional neural network or a comparable deep-learning architecture to perform image recognition; an optical character recognition (OCR) component 124 extracts textual information from images or scanned documents; and a semantic-analysis component 126 applies natural-language-processing techniques to understand the context and meaning of textual data, thereby enabling detection of fraud, phishing attempts, and other malicious communications. The AI analysis module 120 can further employ a Transformer-based architecture and retrieval-augmented generation (RAG) to improve identification of and adaptation to emerging threats. Alternatively or additionally, the AI analysis module 120 may be fine-tuned on diverse datasets on a continual basis to enhance detection accuracy and responsiveness.

More specifically, within the context of the network security system 100, the AI analysis module 120 can call, via an API, a third-party large language model (LLM) 10 (e.g., GPT provided by OpenAI). RAG is used to augment the LLM 10 by integrating external knowledge sources. This approach permits the LLM 10 to retrieve relevant information from large and dynamic databases in real time, thereby improving contextual understanding of the data supplied by the data-intake module 110. By coupling a retrieval mechanism with the LLM 10, the AI analysis module 120 can provide more accurate and context-aware threat assessments, particularly for new or previously unseen threats that may not be fully captured in initial training data. The synergy between RAG and the LLM 10 helps keep the AI analysis module 120 current and adaptive, continuously improving its threat-detection and mitigation strategies.

To tailor a third-party LLM 10 to the specific requirements of the network security system 100, domain-specific fine-tuning may be performed using curated datasets that include examples of harmful content related to sexually explicit material, gambling, drugs, and fraud. Exposing the LLM 10 to a broader range of threat scenarios increases its capability to accurately identify and classify such content. Fine-tuning further aligns the LLM’s responses and detection mechanisms with the system’s operational needs and security policies, ensuring that the AI analysis module 120 provides precise and reliable threat mitigation in real-time environments. By leveraging RAG and fine-tuning, the network security system 100 maintains an adaptive, robust posture that evolves with dynamic threats, enabling high-accuracy detection of known threats while anticipating and mitigating emerging ones.

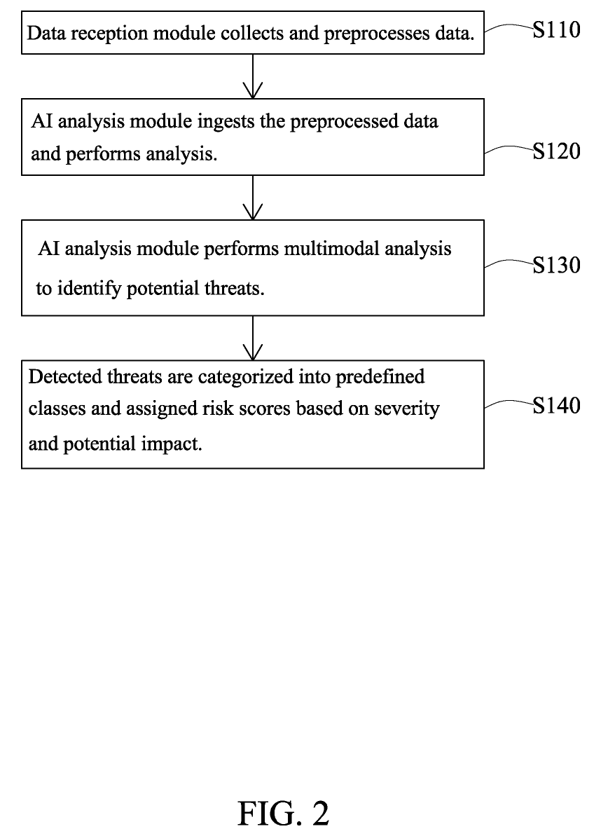

Referring to FIG. 2, which illustrates an example operational flow of the AI analysis module 120, the process begins with step S110, where the AI analysis module 120 initiates data analysis. In step S120, upon receiving preprocessed data from the data-intake module 110, the AI analysis module 120 uses the image-recognition component 122, the OCR component 124, and the semantic-analysis component 126 to commence analysis. In step S130, via multi-modal analysis, the AI analysis module 120 identifies potential threats by detecting patterns, anomalies, and indicators of malicious content. As shown in step S140, detected threats are classified into predefined categories—such as sexually explicit material, gambling, drug-related content, and fraud—and a risk score is assigned based on severity and potential impact. Also at step S140, the AI analysis module 120 generates real-time alerts based on the risk scores and predefined thresholds to notify a user of the identified threats.

Referring again to FIG. 1, the link-analysis module 130 is configured to evaluate safety and legitimacy of URLs accessed by a user. The module employs advanced tracking and risk-scoring mechanisms to assess the trustworthiness of web links, thereby preventing access to harmful or fraudulent websites. In one embodiment, the link-analysis module 130 maintains dynamic lists of known-safe (whitelist 132) and known-dangerous (blacklist 134) URLs. URLs appearing on the blacklist 134 are automatically blocked by the link-analysis module 130, whereas URLs on the whitelist 132 may be allowed without additional analysis. For URLs not present on either list, the link-analysis module 130 invokes the AI analysis module 120 to conduct a comprehensive AI-based evaluation to determine legitimacy.

In some embodiments, the link-analysis module 130 assigns a risk score to a URL based on factors such as domain reputation, historical data, and real-time analytics. URLs deemed unsafe are proactively blocked to prevent inadvertent navigation to malicious destinations. When a user attempts to access a URL, the link-analysis module 130 first checks whether the URL appears on the blacklist 134 or the whitelist 132. If the URL is not found on either list, detailed analysis is performed via the AI analysis module 120 to determine legitimacy. Based on the outcome of the analysis, the link-analysis module 130 decides whether to allow access, present a warning, or block the URL, and provides corresponding visual cues and message notifications through the user-interface module 140.

In a representative implementation, the link-analysis module 130 protects against scenarios in which a user may unknowingly transition from a trusted site to a malicious destination through a sequence of hyperlinks and other navigational events. By applying real-time data analytics, machine-learning techniques, and comprehensive threat intelligence, the link-analysis module 130 evaluates each step in the user’s navigation for safety and legitimacy. The module’s decisions can be surfaced through the user-interface module 140, enabling users to receive timely alerts, review warnings, and take appropriate actions when confronted with potentially unsafe links.

In some embodiments, the link-analysis module 130 protects users in scenarios where navigation may unknowingly transition from a trusted site to a malicious destination through a sequence of hyperlinks and redirects. The module employs techniques that operate at a path level rather than only at a single page level. More specifically, the module detects and records redirects encountered during browsing by parsing HTTP headers to identify HTTP 3xx redirect responses. Each visited URL—including URLs reached via redirects—is recorded to reconstruct a complete navigation path (redirect chain) from an initial trusted site to any intermediate sites and onward to a final destination, thereby accurately reflecting the user’s browsing history for analysis.

Using this reconstructed redirect chain, the link-analysis module 130 applies pattern-recognition and heuristic rules to identify malicious behaviors commonly associated with abuse, including rapid consecutive redirects, obfuscated URLs, and redirects to domains of low reputation. Trained machine-learning models—built on large datasets containing both legitimate and malicious redirect chains—classify the nature of each navigation path. The models evaluate path-level features such as URL entropy, domain age, SSL/TLS certificate validity, and the presence of suspicious query parameters, and they can incorporate additional signals from domain reputation, historical telemetry, and real-time analytics.

Based on the presence of known malicious indicators, historical reputation, and real-time threat intelligence, the link-analysis module 130 assigns risk scores to individual URLs as well as to the overall redirect path. High-risk determinations trigger immediate protective actions—including pre-landing blocking of the destination—while medium-risk determinations may surface warnings that prompt user review. Context is considered when refining risk, including the reputation of the originating site, the user’s recent navigation behavior, and the relevance of the final site to the user’s apparent intent, thereby reducing false positives.

The link-analysis module 130 can be integrated with an external threat-intelligence database 30, allowing the system to ingest up-to-date indicators of malicious domains, phishing sites, and other threats. Crowdsourced reports (e.g., user-flagged URLs) may be incorporated to accelerate discovery of new campaigns. When a high-risk redirect chain is detected, the module blocks access to the harmful destination before landing and immediately notifies the user via the user-interface module 140. The interface may display a color-coded warning (e.g., red for danger) to communicate severity and recommended actions. For medium-risk determinations, the interface may provide cautions and suggestions—such as avoiding certain links or verifying site legitimacy before proceeding.

Behavioral analytics and anomaly detection further augment the link-analysis module 130. By profiling individual browsing patterns, the module can identify deviations from established norms. Unusual navigation sequences or attempts to access restricted domains may trigger additional scrutiny. Unsupervised machine-learning techniques can detect outliers in redirect behavior that may indicate coordinated phishing attempts or drive-by malware downloads, enabling interception of novel threats.

To maintain real-time performance at scale, the link-analysis module 130 can run on a distributed computing framework with load balancing. Horizontal scaling supports increasing data throughput while minimizing latency. Dynamic resource allocation may be used to adapt compute capacity to current threat conditions and user activity levels, maintaining performance and reliability without undue cost.

Consider a user navigating the Yahoo home page, which is generally trusted. The user selects a hyperlink purporting to lead to a news article. The link-analysis module 130 monitors subsequent navigation and detects a sequence of intermediate URLs in the redirect chain. Each hop is analyzed in real time. The first hop resolves to a URL-shortening service, which obscures the final destination. A subsequent hop redirects to a domain with a recently issued SSL certificate and a low domain age, which raises the risk score. Ultimately, the destination URL matches an entry previously labeled in the threat-intelligence database 30 as hosting phishing content. Based on pattern recognition, risk scoring, and corroboration from the threat-intelligence database, the module assigns a high risk to the chain. The system therefore blocks access to the phishing site and surfaces a red danger indicator on the dashboard, preventing the user from becoming a victim.

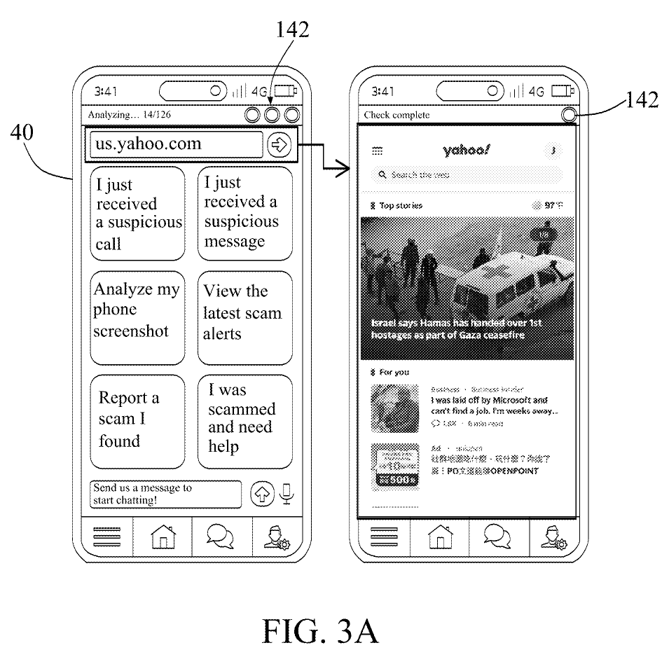

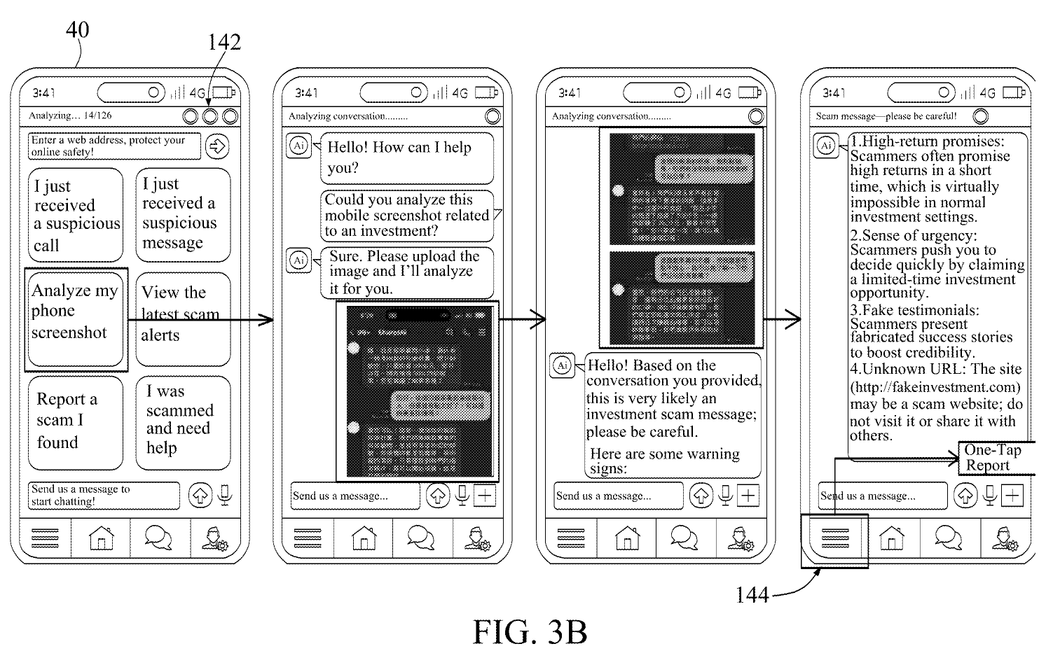

Referring to FIG. 3A, the user-interface (UI) module 140 provides an interactive surface—e.g., on a smartphone 40—through which users interact with the network security system 100, review their online security status, and initiate user-driven operations such as scanning content and reporting suspicious activity. In some embodiments, a prominent feature of the UI module 140 is a status dashboard 142 that presents real-time security indicators via a color-coded scheme (e.g., red for danger, yellow for caution, and green for safe). The dashboard enables users to quickly assess current security posture and take appropriate action as needed.

Referring to FIG. 3B, the UI module 140 supports streamlined input mechanisms through which users can submit content for analysis. For example, a control labeled “Analyze My Phone Screenshot” enables users to upload images (e.g., screenshots) for scanning, thereby initiating proactive analysis of user-selected content. The UI module 140 also includes a reporting tool 144 (e.g., a control labeled “Report a Scam”) that allows users to flag and report suspicious content or activity. In some embodiments, the reporting tool 144 is connected to a government agency server 20, enabling relevant authorities to receive reports of suspicious websites in near real time.

The UI module 140 can be implemented using responsive frameworks to support multiple platforms and device classes, including mobile operating systems such as iOS and Android. This approach provides a consistent, cohesive user experience across devices, and it enables the interface to surface outcomes from the link-analysis module 130—such as pre-landing blocking events, warnings, and risk-score-driven recommendations—in a clear, actionable manner.

Referring again to FIG. 1, a family-monitoring module 145 is integrated with the user-interface module 140 to help maintain a safe online environment for all household members, with particular attention to minors and seniors. In some embodiments, the family-monitoring module 145 implements customized content-filtering and access-control policies in accordance with user profiles established for respective family members. A guardian may create and manage multiple profiles within an application associated with the network security system 100. For each profile, the module 145 can adjust settings and permissions based on factors such as age, observed behavior, and network activity.

The family-monitoring module 145 enforces filtering rules aligned to a selected protection level. For minors, this may include stricter controls against sexually explicit content, gambling websites, and other inappropriate material. For seniors, the system 100 can limit access to websites that are unusually complex or likely to cause confusion, thereby reducing exposure to scams. The module 145 can incorporate behavioral tracking to monitor browsing activity and to enforce filtering rules so that protected users may enjoy safe access while retaining appropriate browsing freedom.

The family-monitoring module 145 may maintain detailed activity logs to enable guardians to review and manage online behavior effectively. In some implementations, the module 145 applies time-based restrictions that limit network usage during specified hours, promoting healthy online habits and preventing overuse. Attempts to circumvent restrictions or to access blocked content can trigger alerts surfaced via the dashboard of the user-interface module 140 so that guardians may intervene promptly.

In certain embodiments, an audio interface 160 integrates speech-to-text (STT) and text-to-speech (TTS) functionality to extend the protective measures of the network security system 100 to audio-based threats, such as fraudulent phone calls or websites that present harmful audio streams. The audio interface 160 permits real-time analysis and response to audio inputs. For instance, the audio interface 160 may employ third-party APIs (e.g., Google Speech-to-Text, Amazon Transcribe/Polly) or proprietary speech models to convert speech into text, after which the transcript is processed by the semantic-analysis capabilities of the AI analysis module 120 to identify indicators of pornography, fraud, or other malicious intent.

When the system 100 detects a potential threat during an audio session, it can generate a voice warning in real time to notify the user and enable immediate action. In various embodiments, the interface can support voice responses from the user—such as terminating a call, requesting further analysis, or executing another predetermined action according to the detected threat level. By extending content analysis to audio channels, the audio interface 160 broadens the system’s coverage beyond visual and textual media and improves protection across communication modalities.

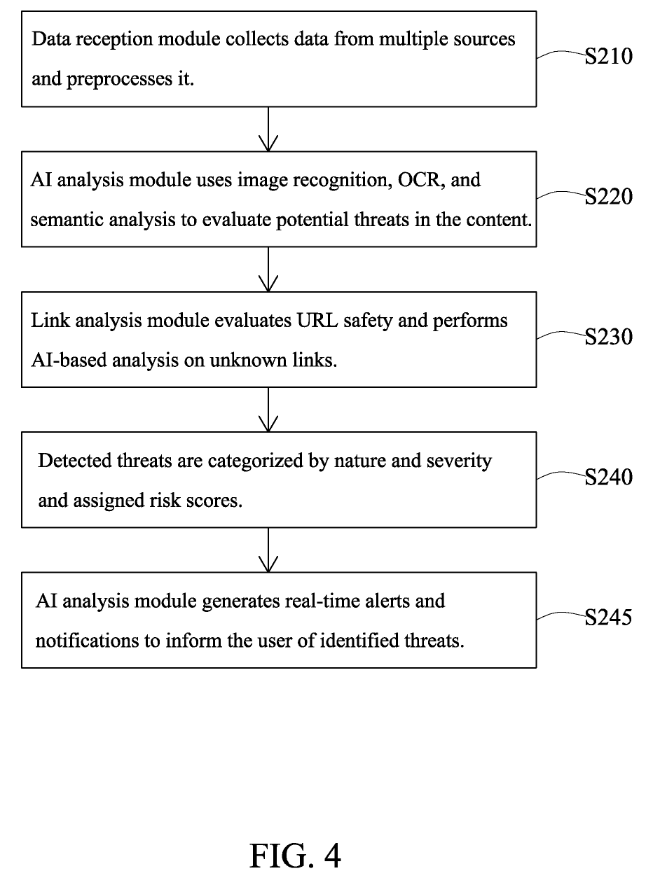

Referring to FIG. 4, the network security system 100 operates through coordinated interactions among its modules. In step S210, the data-intake module 110 collects data from multiple sources, including real-time web browsing, messaging applications, and user-uploaded content. The data-intake module 110 performs preprocessing—such as format normalization, filtering of irrelevant information, and anonymization of sensitive data—to ensure consistency and privacy protection.

In step S220, the preprocessed data is provided to the AI analysis module 120, which evaluates potential threats using the image-recognition, OCR, and semantic-analysis components. In parallel, as shown in step S230, the link-analysis module 130 evaluates URL safety using blacklist and whitelist mechanisms and, for unknown links, requests an AI-based evaluation from the AI analysis module 120. In step S240, detected threats are categorized according to their nature and severity, and respective risk scores are assigned to determine appropriate response levels. Based on the categorization and risk scores, step S245 includes generating real-time alerts and notifications to inform the user of identified threats. The user interacts with the system 100 via the user-interface module 140 to receive alerts, submit content for scanning, and report suspicious activity. The family-monitoring module 145 provides an additional protection layer based on user profiles, while the audio interface 160 processes audio-based threats via STT and issues voice warnings as appropriate.

Personal-use scenario. In one embodiment, a user installs a mobile application associated with the network security system 100 on a smartphone. During browsing, the data-intake module 110 captures URLs and page content. The AI analysis module 120 employs image recognition and semantic analysis to detect harmful elements. By integrating blacklists, whitelists, and AI-based evaluation, the link-analysis module 130 assesses link safety. Upon identifying a potential phishing site, the system 100 blocks access and surfaces a red danger indicator on the dashboard. If the user visits a site presenting audio content, the audio interface 160 converts speech to text, analyzes the transcript, and issues real-time warnings as needed.

Enterprise scenario. In another embodiment, an enterprise deploys the network security system 100 across its corporate network to protect employees from online threats. The system 100 integrates with existing IT infrastructure, and policies are centrally managed—e.g., using capabilities analogous to the family-monitoring module 145 for enterprise profiles. The AI analysis module 120 continuously monitors network traffic, email, and internal communications to identify and mitigate threats such as malware, ransomware, and fraudulent emails. The link-analysis module 130 prevents access to unsafe external sites, and the audio interface 160 can monitor VoIP calls for indicators of social-engineering fraud. The system 100 provides security teams with real-time alerts and detailed analytics to enable proactive threat management and rapid incident response.

Family-monitoring scenario. In a further embodiment, guardians connect household devices to the network security system 100 and create individual profiles for children and seniors. The family-monitoring module 145 enforces strict filtering for children—blocking explicit content, gambling sites, and other harmful material—and simplifies or restricts access for seniors to reduce confusion and fraud risk. Attempts to access restricted websites or to perform suspicious online behavior can be blocked immediately, with notifications presented on the dashboard. The audio interface 160 can monitor phone calls for fraud indicators and present voice warnings to seniors to help prevent financial scams.

Implementation considerations. The network security system 100 may be implemented using a variety of technology stacks and frameworks to achieve optimal performance, scalability, and maintainability. For example, the user-facing applications may be built with responsive frameworks (e.g., React Native, Flutter) to provide cross-platform compatibility and a consistent user experience. Back-end services may be deployed on scalable cloud platforms such as AWS, Google Cloud, or Microsoft Azure, hosting the AI analysis module 120, the link-analysis module 130, and related services. The system can integrate advanced machine-learning libraries and frameworks (e.g., TensorFlow, PyTorch, and Hugging Face Transformers) for developing and deploying detection models. Third-party APIs for speech recognition and synthesis (e.g., Google Speech-to-Text, Amazon Polly) or proprietary APIs may also be used.

Deployment strategies can include continuous integration and continuous deployment (CI/CD) pipelines to streamline development, testing, and rollout of updates. A microservices architecture can increase modularity and allow independent scaling of components. Containerization (e.g., Docker) and orchestration (e.g., Kubernetes) can be employed to manage and deploy microservices, improving scalability and reliability. Monitoring and logging tools (e.g., Prometheus, Grafana) may be integrated to track system performance, detect anomalies, and assist troubleshooting. To maintain real-time processing and handle high data volumes, the system can employ edge computing for localized processing, asynchronous data processing to handle concurrent tasks, and caching strategies to store frequently accessed data and results.

Modifications and alternatives. The embodiments described are not limiting. Different machine-learning models and algorithms may be used within the AI analysis module 120 to enhance detection capability. The system 100 may be extended to additional data sources—such as social-media platforms and Internet-of-Things (IoT) devices—to broaden detection and mitigation. The user-interface module 140 can be further developed to include customizable dashboards, advanced reporting tools, and integrations with other security applications for comprehensive security management. The system 100 may integrate with existing security infrastructure—such as firewalls, intrusion-detection systems (IDS), and antivirus solutions—to form a unified security ecosystem. The system can also be adapted to support multiple languages and regional threat-intelligence databases to improve suitability across geographies and user populations.

The foregoing description details an AI-driven network security system architecture, functionality, and operation. By combining multi-modal data analysis, real-time processing, adaptive learning, and user-centric features, the system 100 provides a robust and flexible solution for mitigating a wide range of cyber threats. Its scalable and adaptable design enables deployment in personal and enterprise environments to address cybersecurity challenges in an increasingly digital and interconnected world.

While the invention has been disclosed through preferred embodiments, the scope of the invention is not limited thereby. Equivalent modifications and variations made by those skilled in the art without departing from the spirit and scope of the invention are intended to be encompassed by the appended claims.

What is claimed is:

1. A computer-implemented network security system, comprising:
component, and a semantic analysis component, the AI analysis module being configured to produce content-level features from the received data and to detect harmful content;

2. The system of claim 1, further comprising a family monitoring module configured to implement customized content filtering and access control in accordance with a user profile.

3. The system of claim 2, wherein the family monitoring module permits a guardian to create and manage multiple user profiles and to provide profile-specific settings and access permissions for each user.

4. The system of claim 1, further comprising an audio interface configured to integrate speech-to-text and text-to-speech functions.

5. The system of claim 4, wherein the audio interface is configured to capture audio streams, convert speech to text, and process the transcript using the semantic analysis of the AI analysis module to identify indicators of fraud or malicious intent.

6. The system of claim 1, wherein the AI analysis module employs a Transformer-based architecture and retrieval-augmented generation (RAG) to improve its ability to identify and adapt to emerging threats.

7. The system of claim 1, wherein the link analysis module manages dynamic lists of known-safe and known-dangerous URLs and performs AI-based evaluation of URLs that are not present in the lists.

8. The system of claim 1, wherein the user interface module includes a status dashboard configured to present the real-time security indicators via a color-coded scheme.

9. The system of claim 1, wherein the AI analysis module employs dynamic machine-learning algorithms capable of continual learning from new data to adapt to and predict emerging threats.

10. The system of claim 1, wherein the AI analysis module generates real-time alerts based on assigned risk scores to notify a user of identified threats.

11. The system of claim 1, wherein the link analysis module is configured to query a threat-intelligence database and to update the path-level risk score in view of indicators received therefrom, and to synchronize entries with dynamic whitelists and blacklists.

12. The system of claim 1, wherein the system is configured to report a suspicious URL and its corresponding redirect chain to a government agency server via a network API.

13. The system of claim 1, wherein the link analysis module is configured to detect URL shorteners and to expand intermediate URLs to determine a resolved destination prior to the path-level scoring.

14. The system of claim 1, wherein the link analysis module is configured to evaluate TLS/SSL certificate validity of domains present in the redirect chain, and to increase the path-level risk score upon detecting an invalid or expired certificate.

15. The system of claim 1, wherein the link analysis module is configured to compute domain age for domains present in the redirect chain and to increase the path-level risk score when the domain age is below a predefined threshold.

16. The system of claim 1, wherein the link analysis module is configured to detect suspicious query parameters within URLs of the redirect chain and to incorporate their presence into the path-level risk score.

17. The system of claim 1, wherein the link analysis module computes the path-level risk score by aggregating node-level and edge-level features across the redirect chain.

18. The system of claim 1, wherein, upon the path-level risk score meeting a blocking condition, the system cancels navigation to the destination and displays a warning via the user interface.

19. The system of claim 1, wherein the AI analysis module comprises a convolutional neural network configured to detect phishing pages by visual similarity.

20. The system of claim 1, wherein the link analysis module is implemented on a distributed computing framework with load balancing to support real-time processing of redirect chains.
